(19) United States
(12) Patent Application Publication
(10) Pub. No.: US 2025/0243885 A1
(43) Pub. Date: Jul. 31, 2025

(54) HOOKING DEVICE FOR PANELS OF PIECES OF FURNITURE

(71) Applicant: ARTURO SALICE S.P.A, Novedrate (IT)

(72) Inventor: Sergio SALICE, Carimate (IT)

(21) Appl. No.: 18/854,497

(22) PCT Filed: Apr. 17, 2023
(86) PCT No.: PCT/EP2023/059863

§ 371 Date: Oct. 4, 2024

(30) Foreign Application Priority Data
May 4, 2022 (IT) 102022000009050

(51) Int. Cl. F16B 5/00; F16B 5/06

(52) U.S. Cl. CPC F16B 5/0084; F16B 5/0614

(57) ABSTRACT

The hooking device (16) for panels (15) of pieces of furniture comprises a base body (17) fixable to a covering panel (15) of the piece of furniture and at least one engagement element (18) connected to the base body (17) and hookable to a support element (11) of a piece of furniture; said at least one engagement element (18) is movable with respect to the base body (17), and drive means (19) are provided for moving said at least one engagement element (18) during an assembling step of the panel (15) on the piece of furniture.

The invention concerns a hooking device for panels of pieces of furniture, in particular a hooking device suitable for connecting panels of wood or of other material to a support element of a walk-in closet or a piece of furniture in general.

In the furnishing sector, walk-in closets or, more generally, furniture structures are variously proposed comprising a plurality of support elements, preferentially in the form of profile elements, which are vertically fixed spaced apart from each other on walls inside homes or shops; support brackets are then fixed to the profile elements for assembling shelves, drawers and other furniture elements, thus allowing to build a walk-in closet or a highly customized piece of furniture according to the needs of containment and support of objects and/or clothes.

The walk-in closets of this kind also comprise covering panels arranged between the profile support elements to cover the walls for aesthetic purposes.

Conventionally, the covering panels are fixed to the support elements by means of suitable hooking devices that comprise a base body, fixable on a rear side of the covering panel, and at least one engagement element connected to the base body and conformed to be hookable to a profile support element.

The engagement element can be, for example, conformed as one or more protrusions or a rib protruding from the base body for engaging in a slit or a groove provided along the support profile elements.

Alternatively, a skull-shaped hooking system can be used with engagement undercuts for the restraint of pins fixed to the panels.

However, due to possible errors in the assembly of the profile elements on the walls and/or assembly errors or due to the sum of the tolerances of all the components of the hooking devices on the covering panels, problems often occur during the hooking step for hooking the covering panels on the support profile elements, since the engagement elements may not be aligned or in any case not in correspondence with the slits provided in the support elements.

Because of this, it is often necessary to reposition and fix again the hooking devices on the covering panels to allow the correct hooking of said panels to the support elements, or in any case there are difficulties in penetrating the engagement elements in the slits of the profile elements.

The object of the present invention is therefore to provide a hooking device for panels of pieces of furniture that allows to assemble said panels easily and safely even in the presence of assembly errors of the profile elements on the walls and/or assembly errors of the hooking devices on the covering panels.

This can be achieved by means of a hooking device for panels of pieces of furniture comprising:
a base body fixable to a covering panel of the piece of furniture,
at least one engagement element connected to the base body, said at least one engagement element being hookable to a support element of a piece of furniture,
characterized in that said at least one engagement element is movable with respect to the base body, and
by comprising drive means for moving said at least one engagement element during an assembly step of the panel on the piece of furniture.

Further characteristics of this invention are also defined in subsequent claims.

The characteristics and advantages of the present invention will be more evident from the subsequent description of a preferential but not exclusive embodiment of the hooking device for panels of pieces of furniture, with reference to the attached figures, in which:

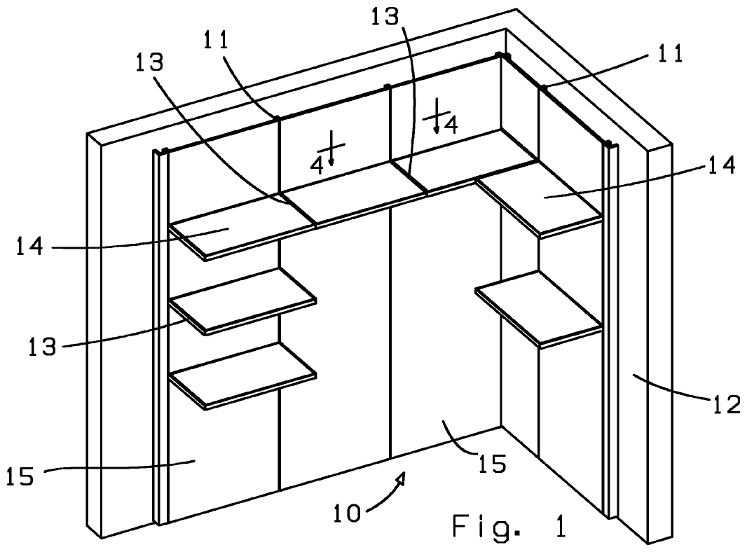

FIG. 1 is a perspective view of a walk-in closet with covering panels mounted by means of hooking devices according to a preferential embodiment of the invention, not visible because they are hidden by said covering panels;

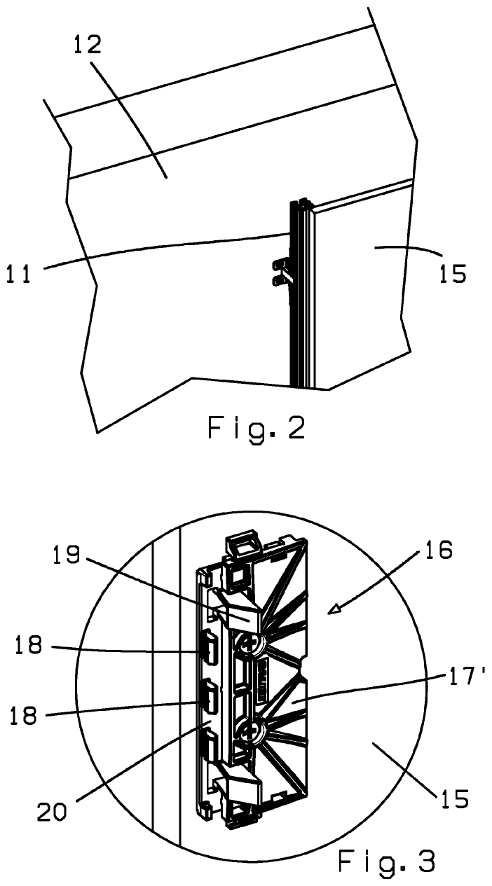

FIG. 2 is a partial view of FIG. 1 in which a covering panel has been removed in the illustrated walk-in closet;

FIG. 3 is a perspective view of the hooking device according to the preferred embodiment of the invention, mounted on a rear side of a covering panel;

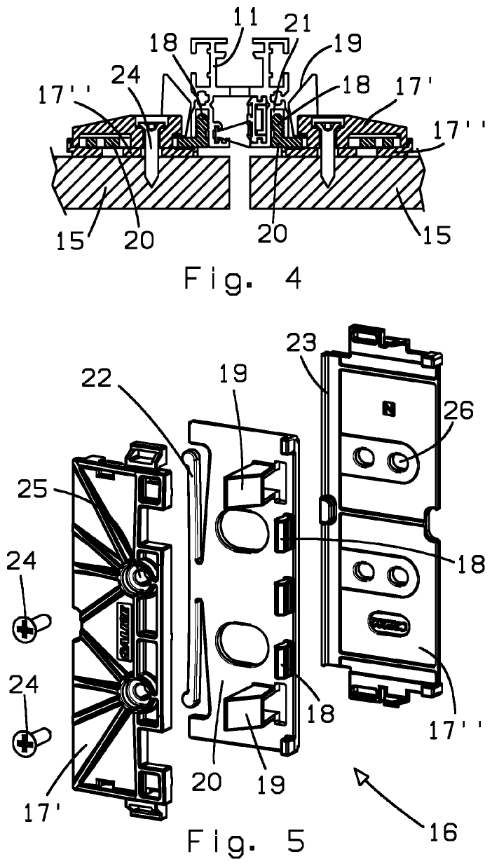

FIG. 4 is a cross-sectional view of the walk-in closet in FIG. 1 according to line 4-4;

FIG. 5 is an exploded perspective view of the hooking device according to the invention; and

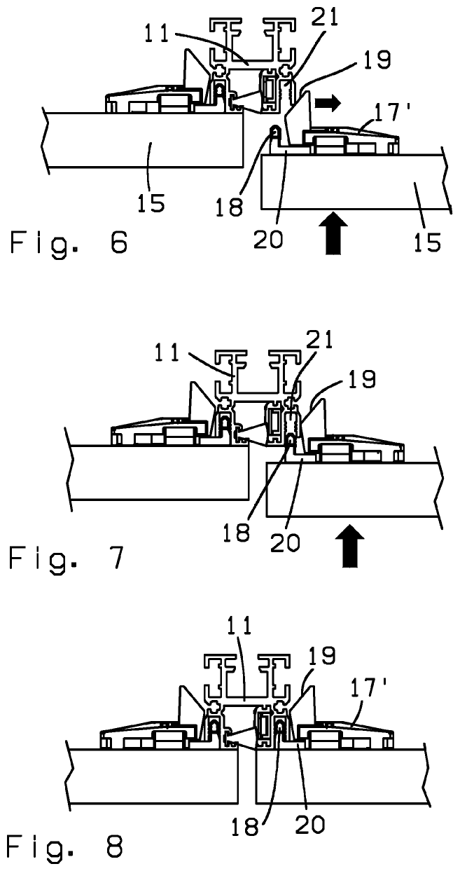

FIGS. 6 to 8 illustrate the plan views of the walk-in closet in FIG. 1 in which different assembly steps of a covering panel on support profile elements are represented in succession.

The figures illustrate the hooking device according to a preferential embodiment of the present invention, which allows the fixing of covering panels to support elements in walk-in closets and furniture in general.

A walk-in closet of the kind in question, indicated as a whole by the reference number 10, generally comprises a plurality of support elements, preferentially conformed as profile elements 11, which are fixed vertically on a wall or support structure 12 inside homes or shops by means of suitable fixing devices not described in detail; however, it is not excluded that the support elements may be structural elements of a generic piece of furniture, for example corner elements constituting the structure of the piece of furniture.

Support brackets 13 are then fixed to the support or profile elements 11 for mounting shelves 14, drawers and other furniture elements, so as to create a highly customized walk-in closet according to the needs of containment and support of objects and/or clothes.

The walk-in closets 10 of this kind also comprise covering panels 15 arranged between the support profile elements 11 to cover the walls 12 for aesthetic purposes.

The covering panels 15 are fixed to the support elements 11 by means of hooking devices 16 which comprise a base body 17, fixable on a rear side of the covering panel 15, and at least one engagement element 18 connected to the base body 17 and conformed to be hookable to a support profile element 11.

According to the present invention, the at least one engagement element 18 is movable with respect to the base body 17, and drive means 19 are provided for moving the said at least one engagement element 18 with respect to the base body 17 during an assembling step for assembling the panel 15 on the piece of furniture.

Preferentially, for the purposes of the relative movement between the at least one engagement element 18 and the base body 17, the at least one engagement element 18 is provided on a slider 20 or a separate body movably supported by said base body 17; alternatively, the at least one engagement element can be solidly realized with the base body, but connected to it, for example, by means of an elastically yieldable part or in any case a connecting element allowing a relative movement between the at least one engagement element and the base body.

In the preferential embodiment in which the at least one engagement element 18 is provided on a slider 20 or on a separate body, the drive means 19 for moving the at least one engagement element are also provided on the slider 20 or on the separate body to cause a movement of said cursor 20 and therefore of the at least one engagement element 18 during the assembly step.

If, on the other hand, the at least one engagement element is solidly realized with the base body, the drive means for moving the at least one engagement element may be provided on or directly connected with the at least one engagement element, for example conformed as a drive surface, or consist of a separate component movably mounted on the base body and conformed to act on the at least one engagement element for moving it.

In general, the at least one engagement element 18 can be for example conformed as one or more protrusions or teeth or one or more ribs protruding from the slider 20 or with respect to the base body 17 for engaging in a slit or a groove 21 provided along the support profile elements 11.

In the preferential embodiment in which the at least one engagement element 18 is provided on a slider 20, the drive means 19 comprise at least one drive element 19 having a slanted or wedge-shaped surface conformed and arranged for contacting a part of a profile element 11 during the assembly step of the panel 15 in such a way to cause a lateral movement of the at least one engagement element 18, preferentially a movement according to a plane parallel to the plane in which the panel 15 lies, for bringing the at least one engagement element 18 at the slit or groove 21 of the profile element 11 and therefore allowing an easy and correct hooking of the at least one engagement element 18 in said slit or groove 21.

Preferentially, the drive means 19 comprise at least a first and a second drive element 19 arranged spaced apart with each other on the slider 20 along a longitudinal extending direction of said slider 20.

As an alternative to the slanted or wedge-shaped surface, the at least one drive element 19 may have a shaped or cam surface so as to cause a movement of the at least one engagement element 18 with a specific motion law.

The at least one engagement element 18 is preferentially movable between an initial forward position, in which it is arranged near a side edge of the panel 15 on which the hooking device 16 is mounted, and a rearward position in which it is moved inwards of the panel 15.

The reciprocal positioning of the engagement elements 18 and drive elements 19 is defined according to the shape of the support profile elements 11 and the arrangement of the slit or groove 21 in said support profile elements 11; preferentially, the engagement elements 18 and drive elements 19 are arranged spaced apart with each other in the direction of movement of the engagement elements 18, with the engagement elements 18 arranged in a forward position with respect to the drive elements 19, and in this case, the slanted surface on the drive elements 19 is slanted and converges in the direction of the engagement element 18.

Preferentially, the hooking device 16 comprises elastic return means conformed and arranged to bias the at least one engagement element to move towards an initial forward position in such a way that, with the panel 15 disassembled, the at least one engagement element 18 always returns to said forward position.

In the event that the at least one engagement element 18 is provided on a slider 20, the return elastic means preferably comprise at least one return spring 22 interposed between the base body 17 and the slider 20; in a preferential embodiment, two return springs 22 are provided in the form of two tabs or elastic arms solidly realized with the slider 20 and protruding from one side of the slider 20 to contact a side wall 23 of the base body 17.

Preferentially, the base body 17 has a flat shape and, in assembling condition, extends parallel to the plane in which the covering panel 15, on which the device is mounted, lies; in the event that slider 20 is provided, preferentially it also has a flat shape and extends parallel to the base body 17.

Preferentially, the base body 17 is formed by two flat half-shells 17′, 17″ coupled with each other by hooking means and/or screws or other fixing means; in this case, the slider 20 is interposed between the two half-shells 17′, 17″ in a suitable housing space defined between them.

The hooking device 16 is fixable on a rear side of the covering panels 15, along their side edges, by means of screws 24 inserted in holes 25, 26 in the half-shells 17′, 17″ of the base body 17 and engageable in the material of the panel 15 or by other suitable fixing means.

In order to allow the installation of the covering panels 15 having different thicknesses, it is possible to interpose special spacing elements or shims between each hooking device 16 and the covering panel 15, so that the position of the front surface of the covering panel 15 can be varied with respect to the profile elements 11.

FIGS. 6 to 8 illustrate the assembly steps of a covering panel 15 by using the hooking device 16 according to the invention.

In particular in FIG. 6, when the covering panel 15 is approached to a profile element 11, if the at least one engagement element 18 is not correctly arranged at the relative coupling slit 21 provided in the profile element 11, the at least one drive element 19 contacts a portion of the profile element 11 and is pushed sideways, bringing the slider 20 to slide parallel to the base body 17 until the at least one engagement element 18 is brought to the corresponding coupling slit 21, as shown in FIG. 7.

In this position, as shown in FIG. 8, the at least one engagement element 18 can then engage in the relative coupling slit 21, so as to hook the covering panel 15 to the profile element 11.

From the above it is evident that the hooking device for covering panels of pieces of furniture according to the invention achieves the aforementioned purposes, as it allows to mount said panels easily and safely even in the presence of errors and assembly tolerances of the profile elements on the walls and/or errors and assembly tolerances of the hooking devices on the covering panels.

The hooking device according to the invention is however susceptible to modifications and variations falling within the scope of the inventive concept; in addition, the construction components can be replaced by technically equivalent elements.

1-10. (canceled)

11. A hooking device for panels of pieces of furniture comprising:
a base body fixable to a covering panel of the piece of furniture,
at least one engagement element connected to the base body, said at least one engagement element being hookable to a support element of a piece of furniture,
characterized in that said at least one engagement element is movable with respect to the base body, and
by comprising drive means for moving said at least one engagement element during an assembling step of the panel on the piece of furniture.

12. The hooking device of claim 1, comprising a slider or a separate body movably supported by said base body, and in that said at least one engagement element is arranged on said slider or separate body.

13. The hooking device of claim 1, characterized in that the at least one engagement element is solidly realized with the base body and connected to the same one by an elastically yieldable part or a connecting element allowing a relative movement between the at least one engagement element and the base body.

14. The hooking device of claim 12, characterized in that said drive means for moving the at least one engagement element are provided on said slider or on said separate body.

15. The hooking device of claim 13, characterized in that the drive means for moving the at least one engagement element are provided on or connected directly with the at least one engagement element.

16. The hooking device of claim 11, characterized in that the at least one engagement element is conformed as one or more protrusions or teeth or one or more ribs protruding with respect to the base body for engaging in a slit or a groove provided along the support elements.

17. The hooking device of claim 12, characterized in that said drive means comprise at least one drive element having a slanted or wedge-shaped surface conformed and arranged for contacting a part of a support element during the assembling step of the panel in such a way to cause a lateral movement of the at least one engagement element.

18. The hooking device of claim 11, characterized by comprising elastic return means conformed and arranged to bias the at least one engagement element to move towards an initial forward position in which it is arranged near a side edge of the covering panel.

19. The hooking device of claim 11, characterized in that said base body, preferentially having a flat shape, is formed by two half-shells coupled with each by hooking means and/or screws or other fixing means.

20. The hooking device of claim 11, characterized by providing spacing elements or shims between each hooking device and the covering panel for mounting covering panels having different thicknesses.
